(19) United States
(12) Patent Application Publication
(10) Pub. No.: US 2006/0282272 A1
(43) Pub. Date: Dec. 14, 2006

(54) Persistent public calendar searching

(75) Inventors: Cinthya R. Urasaki, Seattle, WA (US); Melora Zaner-Godsey, Seattle, WA (US); Tammy L. Savage, Seattle, WA (US); Wende E. Copfer, Bothell, WA (US); Darwin K. Yamamoto, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/152,808

(22) Filed: Jun. 14, 2005

(51) Int. Cl. G06Q 99/00

(52) U.S. Cl. 705/1

(57) ABSTRACT

Persistent public calendar searching is described. A library of public calendars is automatically searched to identify public calendars that may be of interest to a particular user. Public calendars that are identified as being of potential interest to the user are then recommended to the user. If the user selects a recommended public calendar, then the public calendar is integrated with the user's personal calendar so that both the user's personal calendar data and the public calendar data can be presented to the user through the user's personal calendar.

### BACKGROUND

A wide variety of electronic calendars are available to users. For example, most electronic mail applications include a calendar with which users can schedule meetings, appointments, and so on. Personal, web-based calendars are also available that enable a user to track meetings, appointments, birthdays, and so on. Many users enjoy the convenience of web-based calendars that can be accessed from any device with Internet access. Furthermore, many public web-based calendars have also been created by companies, sports organizations, clubs, schools, and so on. Public calendars typically provide read-only access to the public. In addition, many personal, web-based calendars also allow a user to copy or otherwise integrate data from a public calendar into their personal calendar so the user can see all of the calendar data they are interested in through their personal calendar, without having to also access one or more public calendars.

With current systems, for a user to update his calendar with information from a public calendar, the user must go to a library of available public calendars and search for the one that he would like to download into his personal calendar. As more public calendars become available, searching for public calendars of interest to a user becomes more time consuming. Accordingly, a need exists for a personal calendar system that automatically identifies public calendars that may be of interest to a user.

### SUMMARY

Persistent public calendar searching is described. A library of publicly available calendars is automatically searched to identify one or more public calendars that may be of interest to a particular user. The identified public calendars are then recommended to the user. The user may select a recommended public calendar to be integrated with a personal calendar associated with the user. Furthermore, presentation of a user's personal calendar may be customized based on an integrated public calendar.

### BRIEF DESCRIPTION OF THE DRAWINGS

FIG. 1 is a pictorial diagram that illustrates an exemplary network environment in which persistent public calendar searching may be implemented.

FIG. 2 is a pictorial diagram that illustrates an exemplary user interface for rendering personal calendar data.

FIG. 3 is a pictorial diagram that illustrates an exemplary user interface for rendering public calendar recommendations.

FIG. 4 is a pictorial diagram that illustrates an exemplary user interface for rendering personal calendar data along with integrated public calendar data.

FIG. 5 is a pictorial diagram that illustrates an exemplary user interface for modifying user profile data.

FIG. 6 is a pictorial diagram that illustrates an exemplary user interface for removing integrated public calendars from a personal calendar.

FIG. 7 is a block diagram that illustrates select components of an exemplary calendar server.

FIG. 8 is a flow diagram that illustrates an exemplary method for automatically generating public calendar recommendations.

FIG. 9 is a flow diagram that illustrates an exemplary method for integrating recommended public calendar data with personal calendar data.

FIG. 10 is a flow diagram that illustrates an exemplary method for customizing the presentation of personal calendar data based on integrated public calendar data.

FIG. 11 is a pictorial diagram of exemplary computing systems, devices, and components in an environment in which persistent public calendar searching may be implemented.

### DETAILED DESCRIPTION

The embodiments of persistent public calendar searching described below provide techniques for automatically identifying and recommending public calendar data to be integrated with personal calendar data. A calendar application automatically searches a library of publicly available calendars to identify one or more publicly available calendars that may be of interest to a user. The identified public calendars are then recommended to the user. If the user selects a recommended public calendar, then data from the selected public calendar is copied, or otherwise integrated, into a personal calendar associated with the user.

The following discussion is directed to persistent public calendar searching. While features of persistent public calendar searching can be implemented in any number of different computing environments, they are described in the context of the following exemplary implementations.

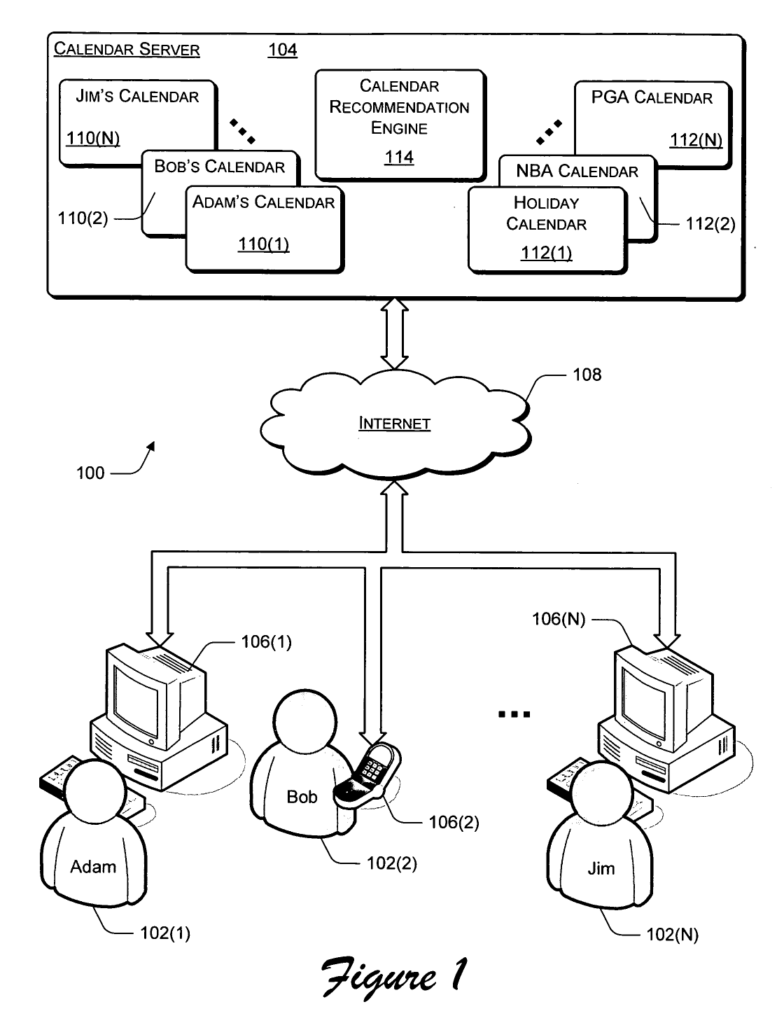

FIG. 1 illustrates an exemplary network environment 100 in which persistent public calendar searching may be implemented. Any number of users, such as Adam 102(1), Bob 102(2), and Jim 102(N) may access calendar server 104 using computer systems 106(1), 106(2), . . . , 106(N) via a network 108 such as the Internet. Computer systems 106(1) and 106(N) are illustrated as desktop computer systems, but may be implemented as any type of computing device capable of accessing calendar server 104 over a network. For example, computer system 106(2) is illustrated as a cell phone. Examples of exemplary computer systems 106 may include, but are not limited to, a desktop computer system, a laptop computer, a cell phone with integrated Internet access, a handheld computing device, and so on.

Calendar server 104 maintains one or more personal calendars, such as Adam's calendar 110(1), Bob's calendar 110(2), . . . , and Jim's calendar 11O(N). Calendar server 104 also maintains (or has access to) multiple public calendars, such as holiday calendar 112(1), NBA calendar 112(2), . . . , and PGA calendar 112(M). As an example, holiday calendar 112(1) may include data that identifies various holidays that occur throughout the year; NBA calendar 112(2) may include data that identifies scheduled professional basketball games; and PGA calendar 112(M) may include data that identifies scheduled professional golf tournaments.

In addition to personal calendars 110 and public calendars 112, calendar server 104 also includes calendar recommendation engine 114, which is configured to automatically identify and recommend one or more of public calendars 112 for integration with one or more of personal calendars 110. For example, calendar recommendation engine 114 may have access to user profile data that indicates that Adam 102(1) enjoys golf. Based on that information, calendar recommendation engine 114 automatically searches for a golf-related public calendar, identifying PGA calendar 112(M). Calendar recommendation engine 114 then generates for Adam 102(1) a recommendation to integrate PGA calendar 112(M) with Adam's personal calendar 110(1). If Adam 102(1) accepts the recommendation, then data from PGA calendar 112(M) is integrated with Adam's calendar 110(1). Calendar recommendation engine 114 may also recommend calendars based on a user's physical location. For example, if a user is accessing the Internet using an Internet-enabled cellular telephone, the user's physical location may be determined based on a global positioning system (GPS) module in the cell phone. Based on the user's physical location, the calendar recommendation engine 114 may then recommend calendars associated with the user's location, such as a calendar of community events for the town in which the user is currently located. In an exemplary implementation, a user may choose to have a “local events” calendar integrated with their personal calendar. Different calendars may then be dynamically associated with the user's personal calendar depending on the user's physical location. For example, as a user moves from one town to another (as determined by GPS module in the user's cell phone), a calendar of events associated with the first town may be removed from the user's calendar, and a calendar of events associated with the new town may be added to the user's calendar.

Data from a public calendar may be integrated with a personal calendar in any number of ways. For example, data from the public calendar may be copied into the personal calendar, and a flag may be generated that causes any changes in the public calendar data to be cascaded down to the personal calendar as well. As another example, a link may be established between the personal calendar and the public calendar such that when the personal calendar is displayed, data from the linked public calendar is also dynamically displayed. In such an implementation, because the data is not copied to the personal calendar, but rather a dynamic link is established, changes to data in the public calendar are also automatically reflected in the personal calendar.

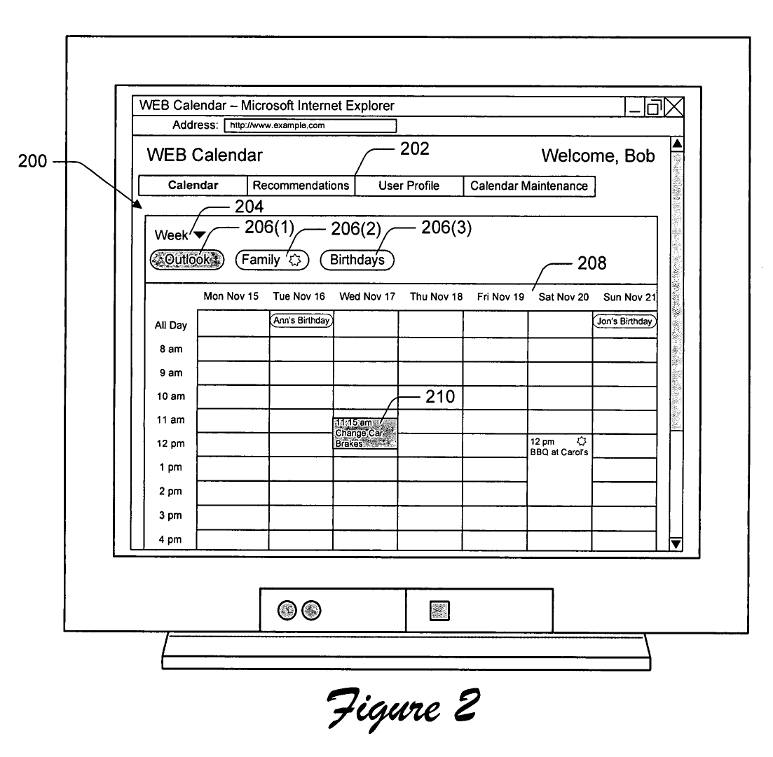

FIGS. 2-6 illustrate exemplary user interface screens that may be implemented to support persistent public calendar searching. Each of FIGS. 2-6 are illustrated on a display device that may typically be associated with a personal computer system. It is recognized, however, that modified user interface screens may also be implemented to support persistent public calendar searching. For example, if implemented for access via an Internet-enabled cell phone, a corresponding user interface may be arranged differently due to the significant difference in available screen real estate.

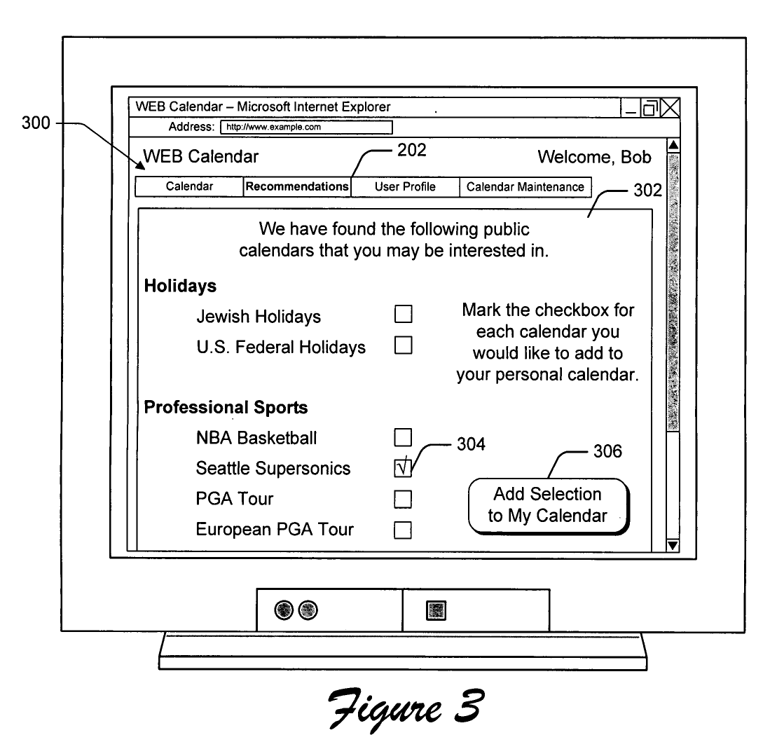

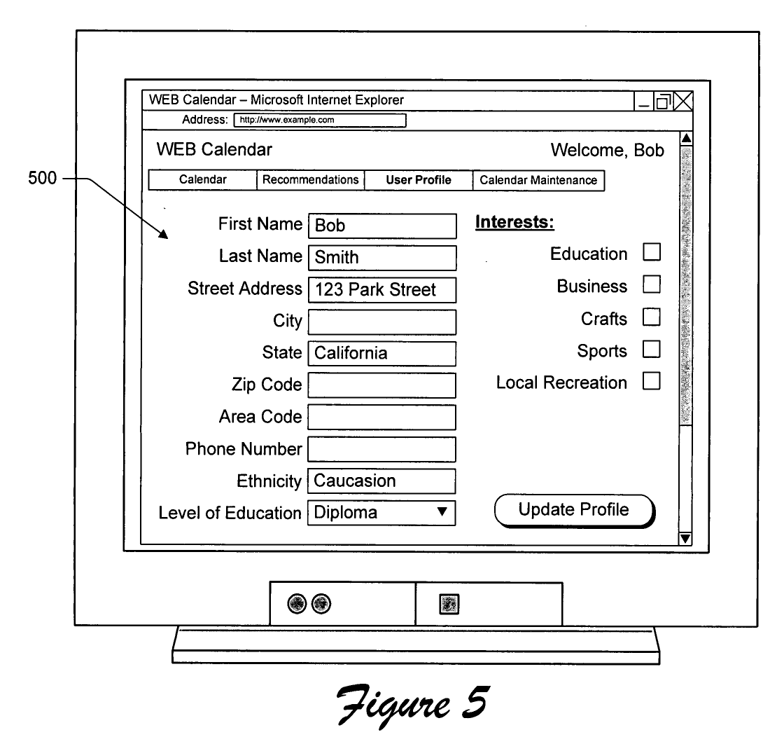

FIG. 2 illustrates an exemplary user interface 200 for rendering personal calendar data. In the illustrated example, user interface 200 is implemented as a web page that includes a menu bar 202, a calendar view selector 204, data category selection buttons 206(1-3), and a calendar area 208. Exemplary menu bar 202 enables a user to select a calendar page (shown in FIG. 2) for interacting with a personal calendar, a recommendations page (shown in FIG. 3) for viewing and selecting recommended public calendars, or a user profile page (shown in FIG. 5) for modifying personal information, which may be used, for example, to identify public calendars to be recommended to the user.

Calendar view selector 204 enables a user to select various views of the personal calendar data, such as a day view, a week view, or a month view. In the illustrated example, data category selection buttons 206(1-3) enable a user to toggle different categories of personal calendar data on or off. For example, calendar data that has been imported from Microsoft Outlook is shown in shaded boxes (e.g., appointment 210). If a user toggles the Outlook button 206(1) off, appointment 210 is removed from the display. If the user toggles the Outlook button 206(1) back on, then appointment 210 is redisplayed.

FIG. 3 illustrates an exemplary user interface 300 for rendering recommendations for one or more public calendars. In the illustrated example, user interface 300 is implemented as a web page that includes a menu bar 202 and recommendations area 302. As described above with reference to FIG. 2, menu bar 202 enables a user to select a calendar page (shown in FIG. 2) for interacting with a personal calendar, a recommendations page (shown in FIG. 3) for viewing and selecting recommended public calendars, or a user profile page (shown in FIG. 5) for modifying personal information, which may be used to identify public calendars to be recommended to the user.

Public calendar recommendations are displayed in recommendations area 302. In the illustrated example, the recommended public calendars are grouped by category (e.g., Holidays, Professional Sports, and so on), and each recommended calendar has an associated checkbox. A user can select a recommended calendar by marking the associated checkbox, such as checkbox 304, which is associated with a recommended Seattle Supersonics public calendar. The user then selects the Add Selection to My Calendar button 306 to integrate the selected public calendar with the user's personal calendar. In an exemplary implementation, public calendars that are already integrated with the user's personal calendar are not listed as a recommended public calendar.

In an alternate implementation, other techniques may also be used for recommending public calendars to a user. For example, an email containing a list of recommended public calendars may be generated and sent to the user, or a recommendation may be presented to a user through an instant messaging application. Furthermore, in some implementations, personal calendars may be shared, for example, by a group of friends or family members. In such an implementation, public calendar recommendations may be presented to one or more of the group members using one or more methods of recommendation (e.g., web page, email, instant messaging, and so on).

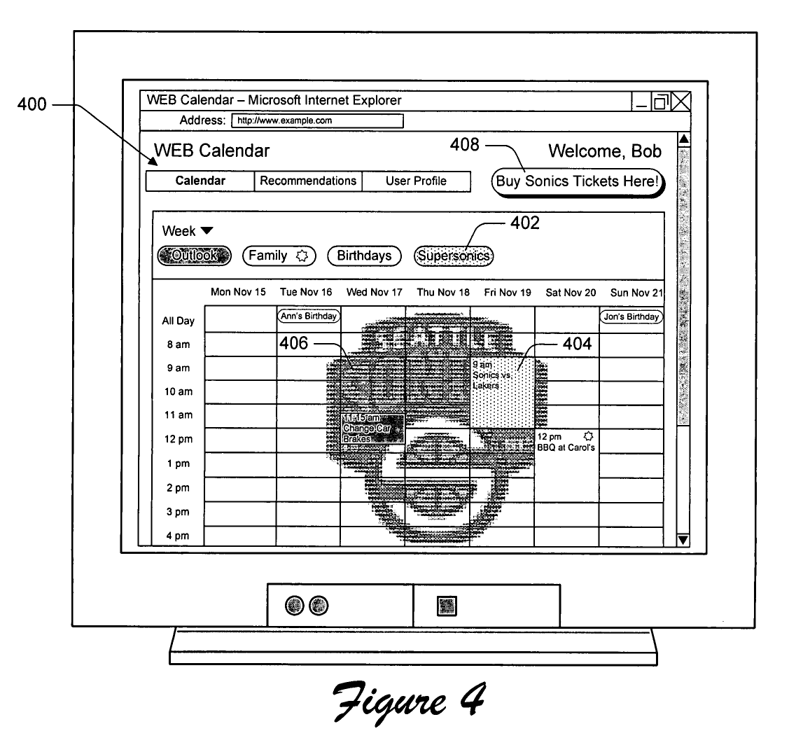

FIG. 4 illustrates an exemplary user interface 400 for rendering personal calendar data along with integrated public calendar data. User interface 400 displays the same personal calendar displayed in FIG. 2, but after integration of a public Seattle Supersonic calendar. In the illustrated example, a new data category selection button 402 is rendered to enable a user to toggle the Seattle Supersonics calendar data on or off. For example, if data category selection button 402 is toggled off, calendar entry 404 will be removed from the display.

In an exemplary implementation, when a user integrates a public calendar with a personal calendar, the user's personal calendar may be customized in some way based on the incorporated public calendar. For example, as shown in FIG. 4, a watermark 406 may be applied to a rendering of the user's personal calendar. Alternatively, advertisements or links to other websites, such as link 408 may be added to a rendering of the user's personal calendar. In an exemplary implementation, a user may be allowed to choose whether or not to allow personalization of their personal calendar based on an incorporated public calendar.

FIG. 5 illustrates an exemplary user interface 500 for enabling modification of user profile data. In the illustrated example, a user is presented with a list of fields for entering biographical type information, any number of which may be completed. The user is also presented with a list of interests that the user may select from. The data entered by the user may then be stored as a user profile, and used to identify public calendars that the user may be interested in. Other techniques for gathering user profile data may also be implemented. For example, biographical and geographical data may be gathered from the user as part of a user sign-up procedure. User behavior, such as web sites visited, may be tracked and used to generate profile data identifying user interests. Any of these and other techniques may be used to generate and/or modify user profile data.

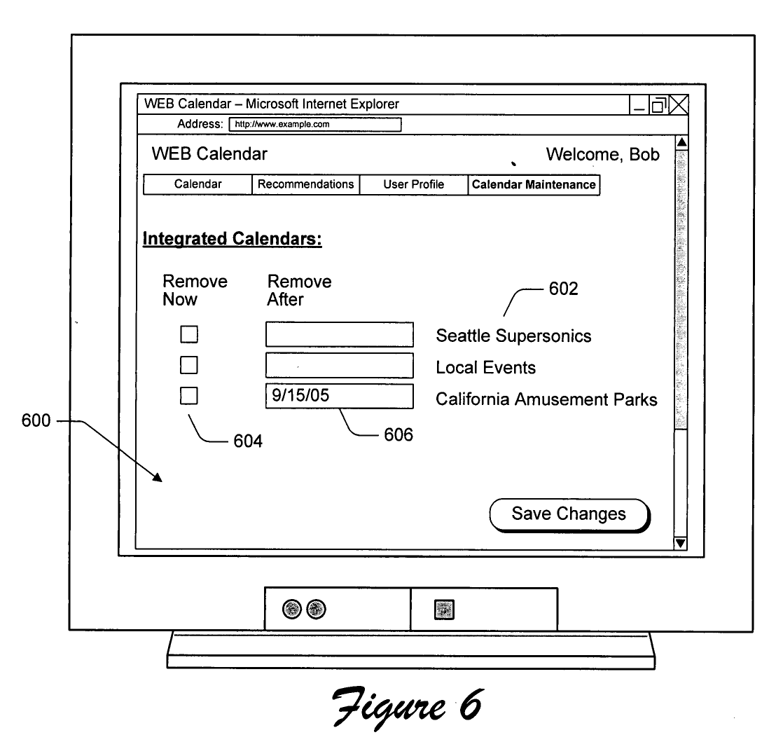

FIG. 6 illustrates an exemplary user interface 600 for removing integrated public calendars from a personal calendar. In the illustrated example, a user is presented with a list of public calendars 602 that, at one time or another, the user has requested be integrated with a personal calendar. If the user wishes to remove a particular one of the integrated calendars from the user's personal calendar, the user can select the remove now checkbox associated with the calendar to be removed. Alternatively, the user can specify a date after which a particular calendar is to be removed from the user's personal calendar. For example, the remove after field 606 associated with the “California Amusement Parks” calendar indicates that the calendar is not to be associated with the user's calendar after Sep. 15, 2005. This may be useful, for example, if a user wants easy access to a particular calendar to help in planning a vacation. After the vacation is over, the user's interest in the calendar may cease.

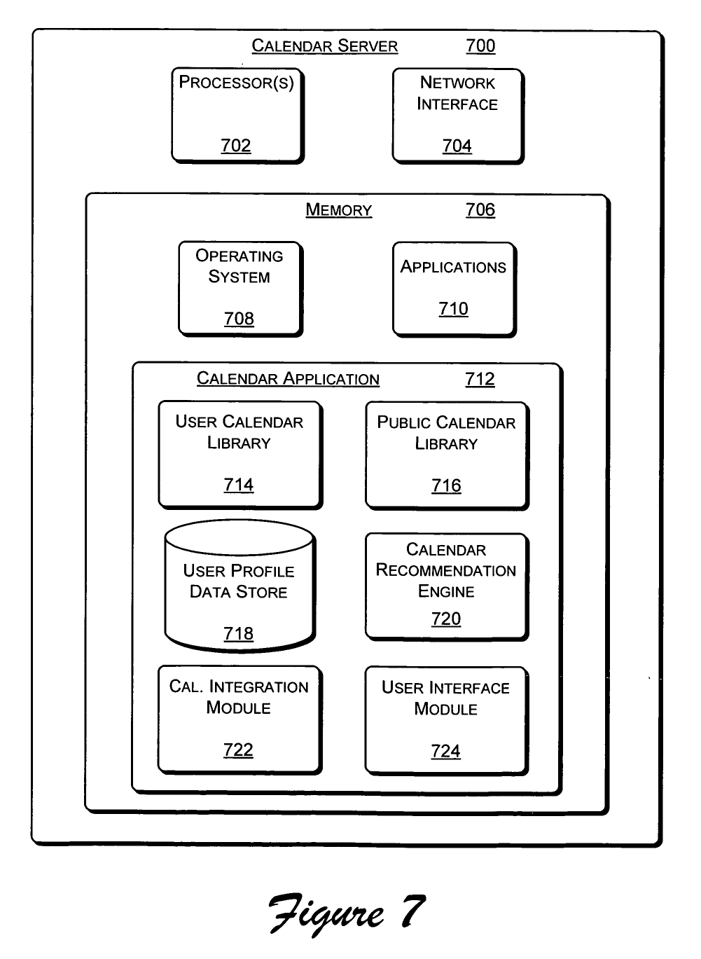

FIG. 7 illustrates selected components of an exemplary calendar server 700 configured to implement persistent public calendar searching as described herein. Calendar server 700 includes one or more processors 702, a network interface 704, and memory component 706. Network interface 704 enables communication between on-demand media server 700 and other computer systems, such as client devices 106(1-N) over network 108. An operating system 708, one or more applications 710, and calendar application 712 are stored in memory 706 and executed on processor 702.

Calendar application 712 includes user calendar library 714, public calendar library 716, user profile data store 718, calendar recommendation engine 720, calendar integration module 722, and user interface module 724. User calendar library 714 is configured to maintain personal user calendars. Public calendar library 716 is configured to maintain publicly available calendars. In an alternate example, public calendars may be maintained by other servers, which may or may not be associated with calendar server 700. For example, entities not associated with a company that provides calendar server 700 may host a public calendar that can be incorporated into personal calendars hosted by calendar server 700.

User profile data store 718 maintains user profile data associated with users of personal calendars. Example profile data is illustrated and described above with reference to FIG. 5. User profile data can include any variety of data including, but not limited to, biographical data, geographical data, hobbies, and interests. Calendar recommendation engine 720 is configured to identify publicly available calendars that may be of interest to one or more users. In an exemplary implementation, calendar recommendation engine 720 may generate search criteria associated with a particular user based on data maintained in user profile data store 718. The generated search criteria are then used to search public calendar library 716 (or to perform a web-based search for other publicly available calendars). Calendar recommendation engine 720 then generates and presents to the user a recommendation for any public calendars that are identified during the search.

In an exemplary implementation, for users having little or no profile data, recommendations may be generated for public calendars that are most popular among personal calendar users. Alternatively, users having little or no profile data may be presented with a long list of available public calendars to peruse, with a suggestion to add or modify their profile data to facilitate the generation of more meaningful public calendar recommendations.

Calendar integration module 722 is configured to integrate a selected public calendar with a user's personal calendar. Any number of techniques may be used to integrate a selected public calendar with a user's personal calendar. In an exemplary implementation, data from the public calendar is copied to the user's personal calendar and the public calendar is then monitored so that modifications to the public calendar can be automatically propagated to the user's personal calendar. In an alternate implementation, a link is established between the user's personal calendar and the selected public calendar so that data from the public calendar may be dynamically presented along with the user's personal calendar.

User interface module 724 is configured to provide a user interface for personal calendar data, personal calendar data with integrated public calendar data, and/or user profile data. Examples of such user interface displays are shown in FIGS. 2-6.

Methods for persistent public calendar searching may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

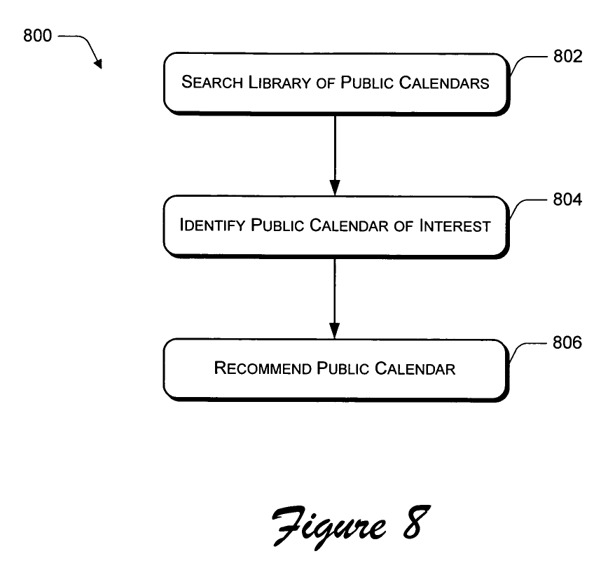

FIGS. 8-10 illustrate exemplary methods for implementing persistent public calendar searching. FIGS. 8-10 are specific examples of persistent public calendar searching, and are not to be construed as limitations. Furthermore, it is recognized that various embodiments may implement any combination of the methods illustrated in FIGS. 8-10 or any combination of portions of the methods illustrated in FIGS. 8-10.

FIG. 8 illustrates an exemplary method 800 for automatically generating a recommendation for a public calendar to be integrated with a user's personal calendar. The order in which the method is described is not intended to be construed as a limitation, and any number of the described method blocks can be combined in any order to implement the method. Furthermore, the method can be implemented in any suitable hardware, software, firmware, or combination thereof.

At block 802, a library of public calendars is searched. For example, calendar recommendation engine 720 searches public calendar library 716 based on data from user profile data store 718.

At block 804, a public calendar of interest is identified. For example, based on user profile data from user profile data store 718, calendar recommendation engine 720 identifies a particular public calendar maintained by public calendar library 716 that may be of interest to a particular user.

At block 806, the identified public calendar is recommended. For example, calendar recommendation engine generates a recommendation for the identified calendar, and communicates the resulting recommendation to the user in any number of ways, including, but not limited to, by email, by instant message, or by a web page.

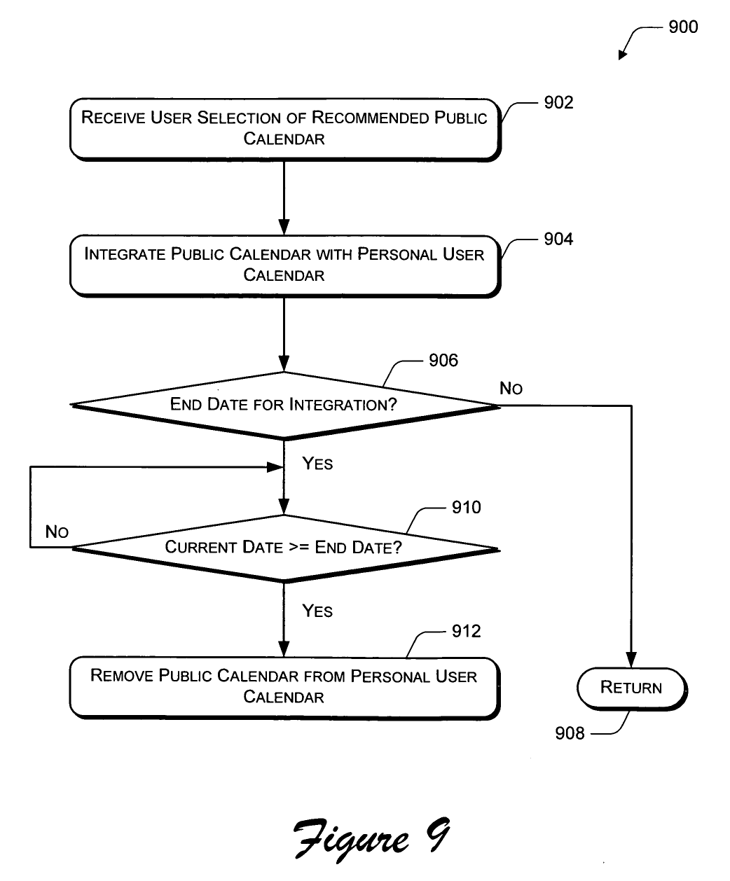

FIG. 9 illustrates an exemplary method 900 for integrating a recommended public calendar with a personal calendar. The order in which the method is described is not intended to be construed as a limitation, and any number of the described method blocks can be combined in any order to implement the method. Furthermore, the method can be implemented in any suitable hardware, software, firmware, or combination thereof.

At block 902 a user selection of a recommended public calendar is received. For example, user interface module 724 receives a user selection of a recommended public calendar through a web page, such as web page 300 shown in FIG. 3.

At block 904, the recommended public calendar is integrated with a personal user calendar. For example, calendar integration module 722 establishes a link between the personal user calendar and the recommended public calendar.

At block 906, it is determined whether or not there is an end date associated with the integration of the public calendar with the personal calendar. For example, as shown in FIG. 6, a user may enter a date after which a particular public calendar is to be removed from the personal calendar. Alternatively, a user may select a remove now option associated with a public calendar, which may set an end data associated with the public calendar to the current date.

If it is determined that there is no end date associated with the public calendar, then at block 908, processing terminates. On the other hand, if it is determined that there is an end date associated with the public calendar, then at block 910, the current date is compared to the end date associated with the public calendar. As indicated by the “No” branch from block 910, processing continues at block 910 until it is determined that the current date is greater than or equal to the end date associated with the public calendar.

When it is determined that the current date is greater than or equal to the end date associated with the public calendar (the “Yes” branch from block 910), then at block 912, the public calendar is removed from the personal user calendar. For example, calendar integration module 722 removes the link that was established between the personal user calendar and the recommended public calendar.

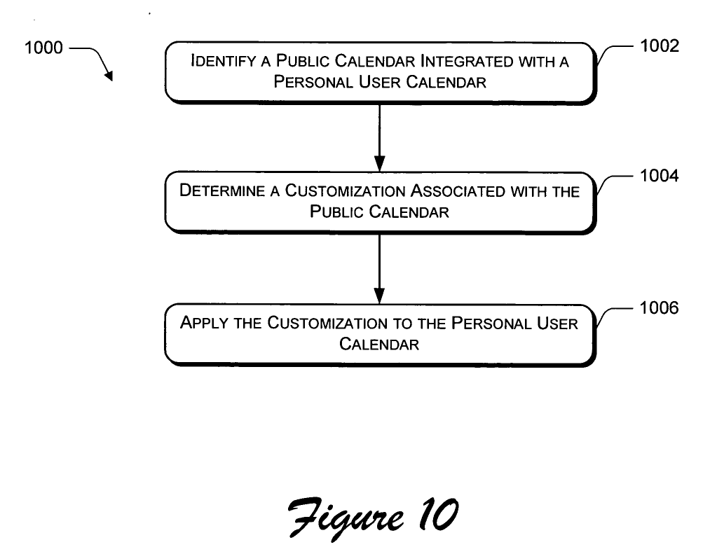

FIG. 10 illustrates an exemplary method 1000 for customizing a presentation of a personal user calendar based on an integrated public calendar. The order in which the method is described is not intended to be construed as a limitation, and any number of the described method blocks can be combined in any order to implement the method. Furthermore, the method can be implemented in any suitable hardware, software, firmware, or combination thereof.

At block 1002 a public calendar integrated with a personal user calendar is identified. For example, a user may request, through a web page, to view their personal calendar, which has a link to a particular public calendar, and the linked public calendar is identified.

At block 1004, a customization associated with the public calendar is determined. For example, the link to the particular public calendar may include data that identifies one or more customizations associated with the public calendar that may be applied to the personal calendar. For example, as shown in FIG. 4, a watermark, advertisement, or link to another web page may be identified as possible customizations.

At block 1006, the determined customization is applied to the personal user calendar. For example, user interface module 724 may present the personal user calendar with the identified customization (e.g., watermark, advertisement, and/or link).

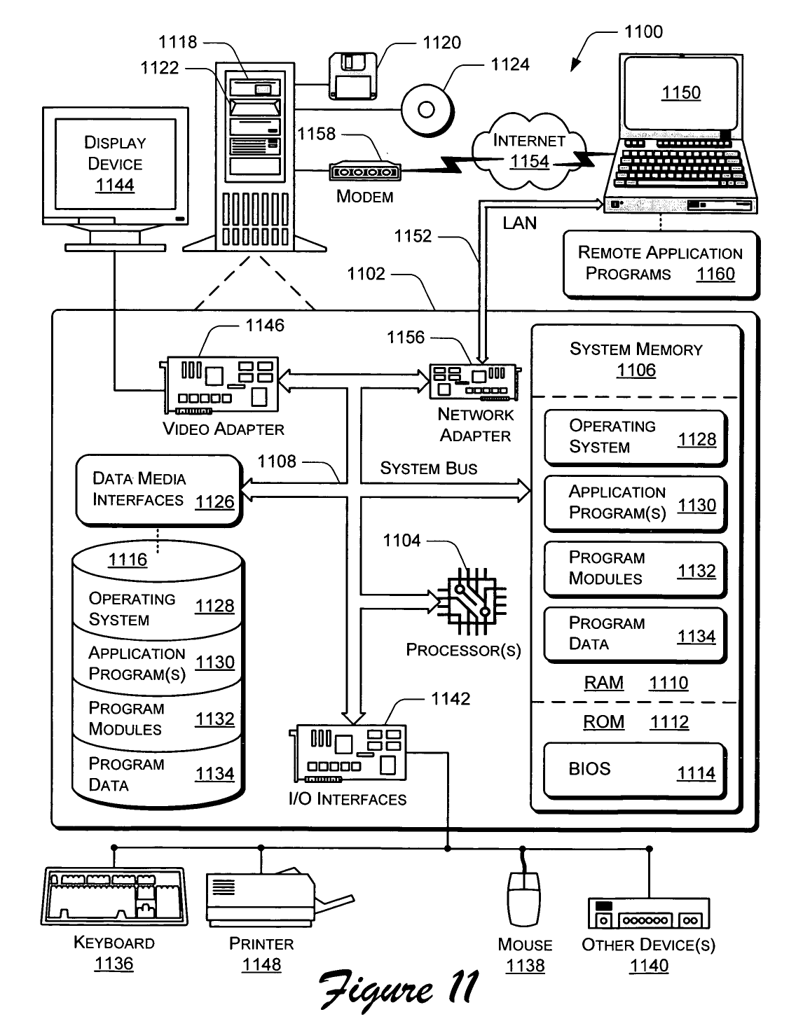

FIG. 11 illustrates an exemplary computing environment 1100 within which persistent public calendar searching systems and methods, as well as the computing, network, and system architectures described herein, can be either fully or partially implemented. Exemplary computing environment 1100 is only one example of a computing system and is not intended to suggest any limitation as to the scope of use or functionality of the architectures. Neither should the computing environment 1 100 be interpreted as having any dependency or requirement relating to any one or combination of components illustrated in the exemplary computing environment 1 100.

The computer and network architectures in computing environment 1100 can be implemented with numerous other general purpose or special purpose computing system environments or configurations. Examples of well known computing systems, environments, and/or configurations that may be suitable for use include, but are not limited to, personal computers, server computers, client devices, hand-held or laptop devices, microprocessor-based systems, multiprocessor systems, set top boxes, programmable consumer electronics, network PCs, minicomputers, mainframe computers, gaming consoles, distributed computing environments that include any of the above systems or devices, and the like.

The computing environment 1 100 includes a general-purpose computing system in the form of a computing device 1102. The components of computing device 1102 can include, but are not limited to, one or more processors 1104 (e.g., any of microprocessors, controllers, and the like), a system memory 1106, and a system bus 1108 that couples the various system components. The one or more processors 1104 process various computer executable instructions to control the operation of computing device 1102 and to communicate with other electronic and computing devices. The system bus 1108 represents any number of several types of bus structures, including a memory bus or memory controller, a peripheral bus, an accelerated graphics port, and a processor or local bus using any of a variety of bus architectures.

Computing environment 1100 includes a variety of computer readable media which can be any media that is accessible by computing device 1102 and includes both volatile and non-volatile media, removable and non-removable media. The system memory 1106 includes computer readable media in the form of volatile memory, such as random access memory (RAM) 1110, and/or non-volatile memory, such as read only memory (ROM) 1112. A basic input/output system (BIOS) 1114 maintains the basic routines that facilitate information transfer between components within computing device 1102, such as during start-up, and is stored in ROM 1112. RAM 1110 typically contains data and/or program modules that are immediately accessible to and/or presently operated on by one or more of the processors 1104.

Computing device 1102 may include other removable/non-removable, volatile/non-volatile computer storage media. By way of example, a hard disk drive 1116 reads from and writes to a non-removable, non-volatile magnetic media (not shown), a magnetic disk drive 1118 reads from and writes to a removable, non-volatile magnetic disk 1120 (e.g., a “floppy disk”), and an optical disk drive 1122 reads from and/or writes to a removable, non-volatile optical disk 1124 such as a CD-ROM, digital versatile disk (DVD), or any other type of optical media. In this example, the hard disk drive 1116, magnetic disk drive 1118, and optical disk drive 1122 are each connected to the system bus 1108 by one or more data media interfaces 1126. The disk drives and associated computer readable media provide non-volatile storage of computer readable instructions, data structures, program modules, and other data for computing device 1102.

Any number of program modules can be stored on RAM 1110, ROM 1112, hard disk 1116, magnetic disk 1120, and/or optical disk 1124, including by way of example, an operating system 1128, one or more application programs 1130, other program modules 1132, and program data 1134. Each of such operating system 1128, application program(s) 1130, other program modules 1132, program data 1134, or any combination thereof, may include one or more embodiments of the persistent public calendar searching systems and methods described herein.

Computing device 1102 can include a variety of computer readable media identified as communication media. Communication media typically embodies computer readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example and not limitation, communication media includes wired media such as a wired network or direct-wired connection, and wireless media such as acoustic, RF, infrared, other wireless media, and/or any combination thereof.

A user can interface with computing device, 1102 via any number of different input devices such as a keyboard 1136 and pointing device 1138 (e.g., a “mouse”). Other input devices 1140 (not shown specifically) may include a microphone, joystick, game pad, controller, satellite dish, serial port, scanner, and/or the like. These and other input devices are connected to the processors 1104 via input/output interfaces 1142 that are coupled to the system bus 1108, but may be connected by other interface and bus structures, such as a parallel port, game port, and/or a universal serial bus (USB).

A display device 1144 (or other type of monitor) can be connected to the system bus 1108 via an interface, such as a video adapter 1146. In addition to the display device 1144, other output peripheral devices can include components such as speakers (not shown) and a printer 1148 which can be connected to computing device 1102 via the input/output interfaces 1142.

Computing device 1102 can operate in a networked environment using logical connections to one or more remote computers, such as remote computing device 1150. By way of example, remote computing device 1150 can be a personal computer, portable computer, a server, a router, a network computer, a peer device or other common network node, and the like. The remote computing device 1150 is illustrated as a portable computer that can include any number and combination of the different components, elements, and features described herein relative to computing device 1102.

Logical connections between computing device 1102 and the remote computing device 1150 are depicted as a local area network (LAN) 1152 and a general wide area network (WAN) 1154. Such networking environments are commonplace in offices, enterprise-wide computer networks, intranets, and the Internet. When implemented in a LAN networking environment, the computing device 1102 is connected to a local network 1152 via a network interface or adapter 1156. When implemented in a WAN networking environment, the computing device 1102 typically includes a modem 1158 or other means for establishing communications over the wide area network 1154. The modem 1158 can be internal or external to computing device 1102, and can be connected to the system bus 1108 via the input/output interfaces 1142 or other appropriate mechanisms. The illustrated network connections are merely exemplary and other means of establishing communication link(s) between the computing devices 1102 and 1150 can be utilized.

In a networked environment, such as that illustrated with computing environment 1100, program modules depicted relative to the computing device 1102, or portions thereof, may be stored in a remote memory storage device. By way of example, remote application programs 1160 are maintained with a memory device of remote computing device 1150. For purposes of illustration, application programs and other executable program components, such as operating system 1128, are illustrated herein as discrete blocks, although it is recognized that such programs and components reside at various times in different storage components of the computing device 1102, and are executed by the one or more processors 1104 of the computing device 1102.

Although embodiments of persistent public calendar searching have been described in language specific to structural features and/or methods, it is to be understood that the subject of the appended claims is not necessarily limited to the specific features or methods described. Rather, the specific features and methods are disclosed as exemplary implementations of persistent public calendar searching.

1. A method comprising:
automatically identifying a public calendar that may be of interest to a user, and
recommending the public calendar to the user.

2. The method as recited in claim 1, wherein automatically identifying a public calendar that may be of interest to the user comprises:
identifying user profile data associated with the user; and
searching a library of publicly available calendars based on the user profile data.

3. The method as recited in claim 1, wherein automatically identifying a public calendar that may be of interest to the user comprises:
determining a physical location currently associated the user; and
searching a library of publicly available calendars based on the physical location.

4. The method as recited in claim 1, wherein the recommending comprises at least one of displaying a list of recommended public calendars, sending the user an email that includes a reference to the public calendar, or sending the user an instant message that includes a reference to the public calendar.

5. The method as recited in claim 1, further comprising:
receiving a user selection of the public calendar; and
integrating the public calendar with a personal calendar associated with the user.

6. The method as recited in claim 5, wherein the integrating comprises at least one of establishing a link between the personal calendar and the public calendar so that data from the public calendar can be dynamically presented when the personal calendar is presented, or copying data from the public calendar to the personal calendar.

7. The method as recited in claim 5, further comprising:
determining an end date after which the public calendar is not to be integrated with the personal calendar associated with the user; and
in an event that a current date is equal to or after the end date, segregating the public calendar from the personal calendar such that data associated with the public calendar is no longer presented when data associated with the personal calendar is presented.

8. The method as recited in claim 7, wherein segregating the public calendar from the personal calendar comprises removing a link between the public calendar and the personal calendar.

9. The method as recited in claim 5, further comprising:
identifying a change in the public calendar; and
propagating the change to the personal calendar associated with the user.

10. The method as recited in claim 5, further comprising:
identifying a customization associated with the public calendar; and
applying the customization to at least a portion of the personal calendar associated with the user.

11. The method as recited in claim 10, wherein the customization comprises at least one of a watermark image, a color scheme, an advertisement, or a link to a web page.

12. A network-based calendar system comprising:
a user calendar;
multiple public calendars; and
a calendar recommendation engine configured to automatically recommend one of the public calendars to be integrated with the user calendar.

13. The system as recited in claim 12, wherein the calendar recommendation engine is further configured to automatically search the public calendars for a public calendar to be recommended.

14. The system as recited in claim 12, further comprising a user profile data store, wherein the calendar recommendation is further configured to automatically search the public calendars based on user profile data maintained by the user profile data store.

15. The system as recited in claim 12, further comprising a calendar integration module for integrating a recommended one of the multiple public calendars with the user calendar.

16. The system as recited in claim 12, further comprising a user interface module for presenting to a user at least one of a personal calendar, a recommendation to integrate a public calendar, or a personal calendar with integrated public calendar data.

17. One or more computer-readable media comprising computer-readable instructions which, when executed, cause a computer system to:
identify profile data associated with a user;
search a library of publicly accessible calendars based on the profile data;
identify a publicly accessible calendar that may be of interest to the user based on the profile data; and
recommend the publicly accessible calendar to the user.

18. The one or more computer-readable media as recited in claim 17, further comprising computer-readable instructions which, when executed, cause the computer system to integrate data from the publicly accessible calendar with a personal calendar associated with the user.

19. The one or more computer-readable media as recited in claim 18, further comprising computer-readable instructions which, when executed, cause the computer system to integrate data from the publicly accessible calendar with a personal calendar associated with the user by establishing a dynamic link between the personal calendar and the publicly accessible calendar such that data associated with the publicly accessible calendar may be dynamically displayed along with data associated with the personal calendar.

20. The one or more computer-readable media as recited in claim 17, further comprising computer-readable instructions which, when executed, cause the computer system to apply a customization associated with the publicly accessible calendar to a personal calendar associated with the user.
